(19) United States
(12) Patent Application Publication
(10) Pub. No.: US 2017/0147982 A1
(43) Pub. Date: May 25, 2017

(54) DYNAMIC SYSTEM FOR HUMAN RESOURCE NETWORKING

(71) Applicant: EMPLEOLISTO LATIN AMERICA SAPI DE CV, Distrito Federal México (MX)

(72) Inventors: David Miles Reich, Mexico Distrito Federal (MX); Joshua Chaitin-Pollak, South Salem, MA (US)

(73) Assignee: EMPLEOLISTO LATIN AMERICA SAPI DE CV, Distrito Federal México (MX)

(21) Appl. No.: 14/946,396

(22) Filed: Nov. 19, 2015

(30) Foreign Application Priority Data
Nov. 19, 2015 (MX) MX/A/2015/15916

(51) Int. Cl. G06Q 10/10

(52) U.S. Cl. CPC G06Q 10/1053

(57) ABSTRACT

The invention is related to the system and information management processes among multiple databases that are updated online and interact according to instantaneous evaluation of the information.

### TECHNICAL FIELD OF THE INVENTION

This invention is related to a system of information management and connecting people to employment opportunities through a network of predetermined user skills and attributes using mobile devices and computers; for job posting, following up, recruiting, and linking job vacancies with a database of candidate information based on questions and answers updated online and registered in real time.

The invention is designed in a way which allows the user to interact with the invention through at least four ways, namely: SMS messaging system for mobile phones, native apps for electronic devices, web sites and via voice calls.

### STATE OF THE ART

In the past, the linking of job offers and possible candidates was carried out in two ways: the first one was searching for job offers or possible candidates by means of publications in print media. That way did not allow efficient recruitment due to the large volume of candidates with widely different qualifications which did not always meet the requirements of the published job offer.

The second way was through the use of outsourcing offices which search for candidates by means of complicated classification and selection processes that lack selection criteria to link jobs candidates within a certain geographical parameters close to the candidate's home address.

The evolution of communication systems, the internet and digital media, have allowed companies and candidates to create more effective connections, allowing candidates to generate their own job profiles and allowing human resource departments to match job offers with candidates that meet specific job requirements. Nowadays, companies search for talent in different social networks, such as Facebook and LinkedIn. The social networks allow the candidates to generate job profiles and collaborative networks which are useful tools for companies to publish job offers. However, in lower socioeconomic populations, a computer is not always available. Therefore, a system with ubiquitous access on mobile devices that do not have internet access is required.

The patent application WO2013/126835 refers to the construction of a job reference network in order to selectively communicate job opportunities for potential job references and to facilitate anonymous job referrals. A computer system imports the professional contacts of a job candidate from a database of professional contacts. The system categorizes the professional contacts according to the criteria given by employers of job search companies, selectively communicating job opportunities.

However, the application does not mention that the system can contact the jobseekers by means of SMS (Short Message Service) messages, and the job interview to which the jobseeker went to, will go to or have been cancelled are also not mentioned. In contrast, the invention presented in this document incorporates a database of user profiles that can be identified in the management system, as the user profile changes over time records of historical values will be saved and available for reference.

The patent application WO2013/052769 refers to a communication system between ATS platforms (Applicant Tracking System) such that candidates nominated to fill a vacancy are not shown the same job repeatedly. This patent application does not mention the use of a mobile platform in which short SMS text messages with job offers are sent to job seekers that meet his or her stored profile, and also does not mention that the system of the patent application WO2013/052769 can manage job interviews or remind the user about scheduled work appointments.

The patent application US 2013/0046704 discloses a recruitment method, which, once the candidates have registered their data and work interests, compares job offers with the candidate information. If they are compatible, an SMS (a short message service or a message by means of other communication path) is sent with the information about the vacancy. If the user decides to apply for it, he or she replies with another SMS stating their interest in the vacancy, and the candidate information is then sent to the employer or recruiter. However, this patent application does not include a method that can manage interview requests or keep track of the interviews given by the candidate, and sorting through similar offers declined by the candidate under previously established criteria. It also does not report that the method can manage an appointment calendar and reminders for job interviews already accepted by the candidate.

As described above, a system for candidate information and job offer management is needed, used by means of a mobile phone and other mobile devices and electronic alerts within programs, which manage job offers and candidate information under previously established criteria. There is also a need to create a system, which would allow appointment calendar management and send reminders of scheduled job interviews.

Such a system should also be easily accessible to the user, such that the databases that manage each user profile data are optimized to include geolocation data and the user's preferences and socio-economic profile in order to minimize the time to connect the candidate with a suitable vacancy.

### BRIEF DESCRIPTION OF THE INVENTION

The system of the innovation has been designed in order to generate dynamic matches, which optimize the interaction between the candidate and the employer by leveraging mobile phones through the use of SMS messages. A series of questions related to the job profile are sent to the candidate who can then respond with answers via SMS. The answers to questions are stored in a database as a record within the user profile. Through comparative methods, the system extracts information from the databases associated with job vacancies and candidates based on criteria established by the vacancy or the user, which facilitate the information management, allowing the generation of dynamic and appropriate interactions with specific profiles.

The dynamic system for matching information, based on the stored and organized information, allows for an innovative optimization in managing a system, which identifies common criteria between the employer and the potential employee.

Existing platforms generally require that the candidate initially and immediately give data including but not limited to the candidate's experience, educational degrees attained and previous jobs, and this information is stored and categorized in inflexible and permanent fields. As more information is added to the database, this candidate data is not modified or linked to other dynamic databases, which could alter the number or structure of the fields.

The present invention, however, allows the generation of dynamic interactions among the employer, the candidate, databases of job vacancies and jobseekers, as well as historical data, when information is entered. This is done by associating atomic clocks, which establish time periods in which the information contained in the databases will be extracted and sent. This is the main difference regarding the optimization when comparing the searched profile and the user profile, since the system is dynamic and allows simultaneous interaction between different databases, developing a comparative analysis of the answers to each question for each profile. The questions are stored in a specific and defined database as a benchmark in the system. The answers to each question, given by the users interested in the specific job, are stored and associated with each user's profile. A comparative process is carried out based on the answers instead of the rigid and permanently defined information such as the specific fields of a curriculum vitae.

Unlike other platforms that use electronic mail (email), the invention has different databases to link not only information fields associated to the user profile, but also questions and answers in a comparative approach with other users. The information contained in e-mails cannot be linked; a search and comparison procedure cannot identify the predefined fields or types of information.

Similarly, the system is flexible since it allows the addition of new questions (criteria) either to the employer's job post or to the jobseeker's profile. This can be achieved by establishing different sets of questions which link to both a user profile and the job profile, i.e. a simultaneous multi-criteria analysis is performed. It also registers historical values of both the job profile and the user profile. The comparative interaction among dynamic databases allows for optimized analysis, including specific geolocation data. Additionally, a text analysis of questions and answers associated to the user profile is carried out, identifying phrases and common text. This allows for a more accurate correlation between the user and job profiles.

An additional characteristic of this platform is that each question has a period of validity or other expiration critiera so the system automatically checks and updates the candidate's answer to the question. This happens either when the user begins a new search for a job or to the criteria defined by the person who created the question. The process of refreshing and updating the answer to the question, which is stored as part of the user profile, allows the profile matching process to be optimized and kept up to date. To illustrate the link between information and how the system and databases operate consider a candidate who is asked if they can drive a manual transmission car. At the time they create their profile, they can only drive a car with an automatic transmission so they answer ‘No’ to the question. This information is received, registered and classified while it is linked to the databases of available job offers. If the user later learns to drive a car with standard transmission, then when the answer expires, the system will prompt the user to answer the question again and the user will answer ‘Yes’. Then through a process of validation it will detect the change and update the links in the databases to each of the associated job offers and subsequent types of questions that could be asked of the user.

The system, besides linking multiple databases simultaneously and dynamically, has validity criteria for certain databases. Similarly, the validity status of a question can be linked or conditioned on the answer to another question. This comparative system not only allows the information to be updated but also to adapt to changes in the user profile and job type desired, by means of algorithms which provide simultaneous and dynamic comparisons of flexible databases.

The database also stores each variable and changes in information so multi-variable reports can be carried out based on changes over time. Likewise, the platform allows definitions of specific variables and comparison of information, once the criteria are fulfilled; the system sends a message automatically. If the user answers, the system stores this information and allows the creation of groups of candidates who share certain characteristics.

Another innovative aspect of the platform is using the databases and collected information to tracking the time taken for each user to find a job and using this information to optimize which questions are necessary to match candidates to jobs optimally. This method will be described below.

### DESCRIPTIONS OF DRAWINGS AND CHARTS

FIG. 1 shows a high-level flowchart of the process of receiving a job offer.

FIG. 2 shows a high-level flowchart of the process of receiving a job candidate.

FIG. 3 shows a high-level flowchart of the process of the management of job offers and candidates.

FIG. 4 shows a functional diagram of the invention's use of atomic clocks linked to dynamic databases.

FIGS. 5, 6, 7, 8, 9, 10 and 11 are graphic representations of various user interfaces that a candidate may use, for example via web and via mobile (SMS), however any other interface can be used (e-mail, social network, native apps, for example).

### INVENTION SPECIFICATIONS

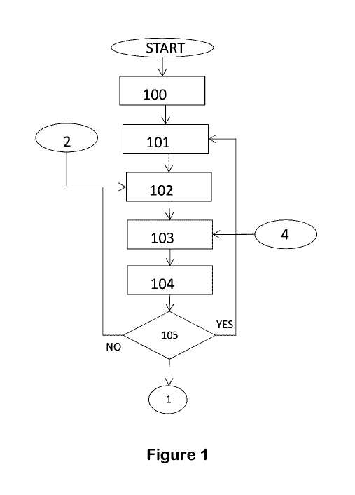

In FIG. 1, a high-level functional diagram is shown of the event in which the system receives (100) a job offer by an employer. The system can receive this information via mobile phones, e-mails, web sites and native apps (Android, IOS, etc.) and voice or video data. The job offer contains the criteria required on a candidate profile, for example, age, job location, job type, field of expertise and information of the employer. Each job offers is stored (102) in a job database (JDB), after assigning identification data (101). The identification data can be related to the date of the offer, employer information, salary, location, among other information, which will allow creating graphs related to the employers, for example, jobs offered, post frequency by field and geographic location, etc.

A candidate's data “search engine-classifier” (SEC) (103) compares the available job offers in the database (JDB) (102) in real time with the job offers in an historical archive (104) in order to determine if the same employer has published similar job offers. The data browser-classifier SEC then asks (105) the employer if the job offer is new for a new position opened or if it is an update of a previously published job offer. If it is an update, the system updates the data (102) of the previous job offer. If it is for a new, unique job offer, it is stored in the job database (101) (JDB).

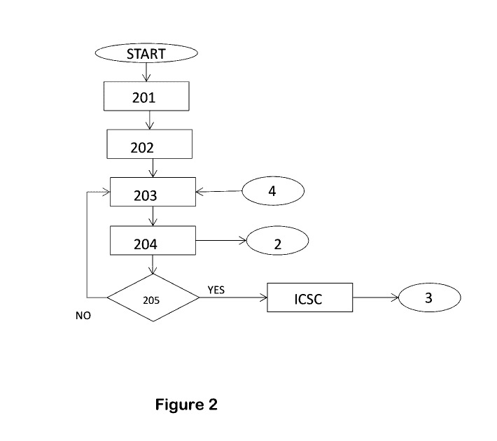

FIG. 2 shows the process of receiving a candidate's job application. First, a job application is done by a candidate via an electronic device (201), the application is identified (202) through a user profile and is stored in a candidate database (CDB) (203) which is in constant communication with the job offer database (102) by a data engine-classifier (204), which compares the characteristics required by the job offer database (102) and the candidate database (203). If the information extracted from the candidate database (203) by the search engine-classifier meets the required characteristics (205), such information is sent to the information and contact storage center (ICSC), otherwise it continues comparing until the information meets the established criteria.

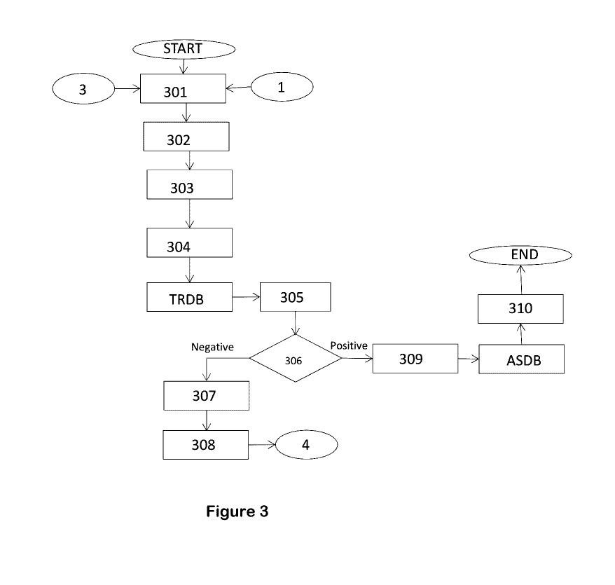

FIG. 3 shows the combination of the results obtained in FIGS. 1 and 2, so that the information and contact storage center (ICSC) identifies (301) the preferred means to receive the information, which meets their requirements by both employers and candidates. Once the preferred communication medium has been identified (302), the store center sends (303) an electronic communication to both parties, which can be e-mail, SMS, Whatsapp®, Twitter®, Facebook®, fax, among other choices. Such communication might contain details about the employer or the candidate.

Both the employer and the candidate can accept or decline a candidate or a job offer using an electronic response. The response is received on a gateway (304) of a tracking database (TRDB), which stores the answers and classifies them. The tracking database then searches the database depending on a negative or positive response (305) and sends a questionnaire in a second electronic communication (306) to the candidate or to the employer, so if it was a negative reply to the first job offer or candidate, additional information regarding an employer or candidate can be obtained (307). These new characteristics will be part of the data search engine-classifier (103 or 203) in order to repeat (308) the steps (203 to 205) until the employer and candidate are unsubscribed from the databases or the job offer is no longer available.

In case of a positive condition (306) regarding a job offer or candidate, a pairing request is sent (309) to an appointment scheduler database (ASDB) where the characteristics associated to an appointment are established, for example date, hour and location. The appointment scheduler can send (310) appointment reminders, under pre-established conditions, to the electronic media chosen by an employer or a candidate. The appointments cannot be scheduled at the same hour and date avoiding confusions and logistic problems.

The invention system besides the interaction processes described has a user profile record regardless of the user's access point, which optimizes the registration and historical information. Also, the historical data allows creating reports regarding job offers, user or employee's skills, even after the user has completed a working relationship and is looking for a new job. This information is stored and classified in order to be accessible and generate reports.

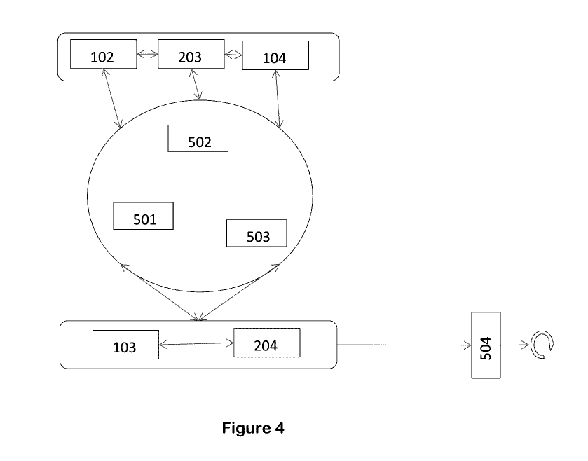

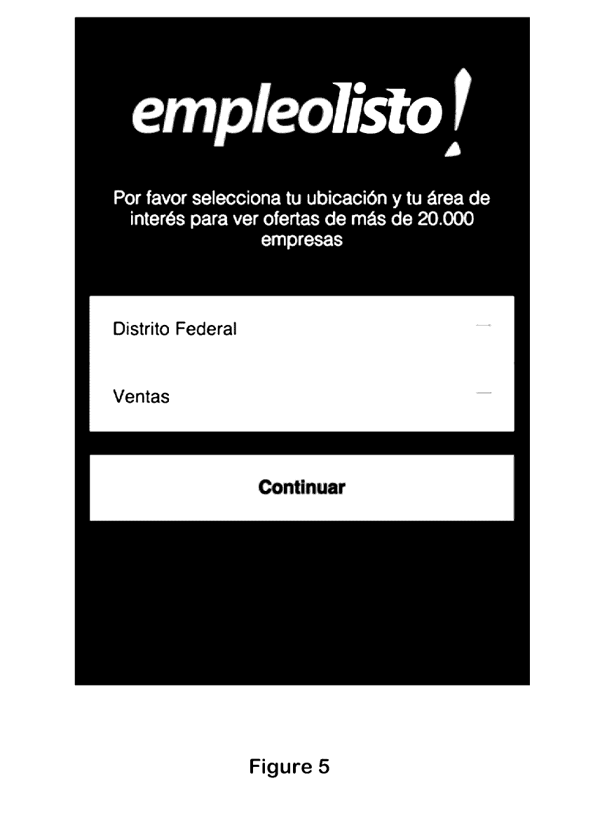

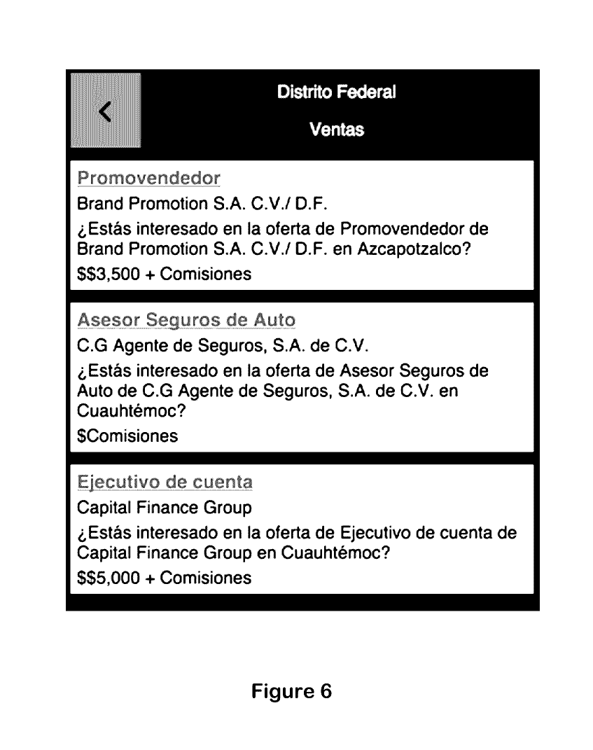

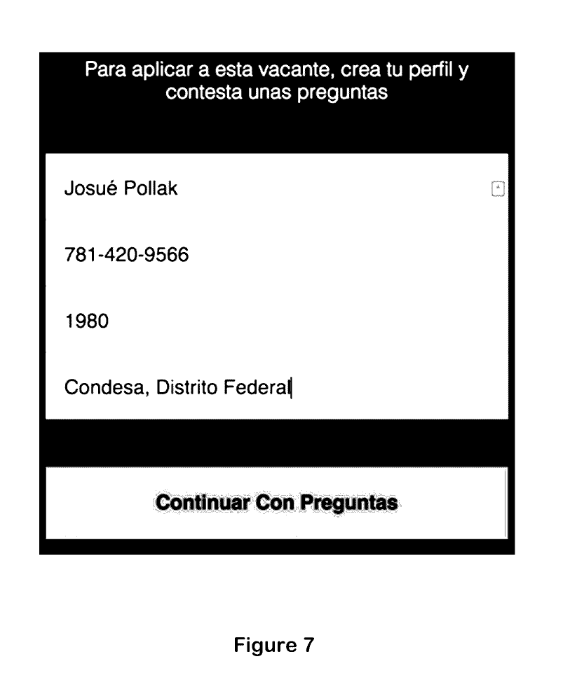

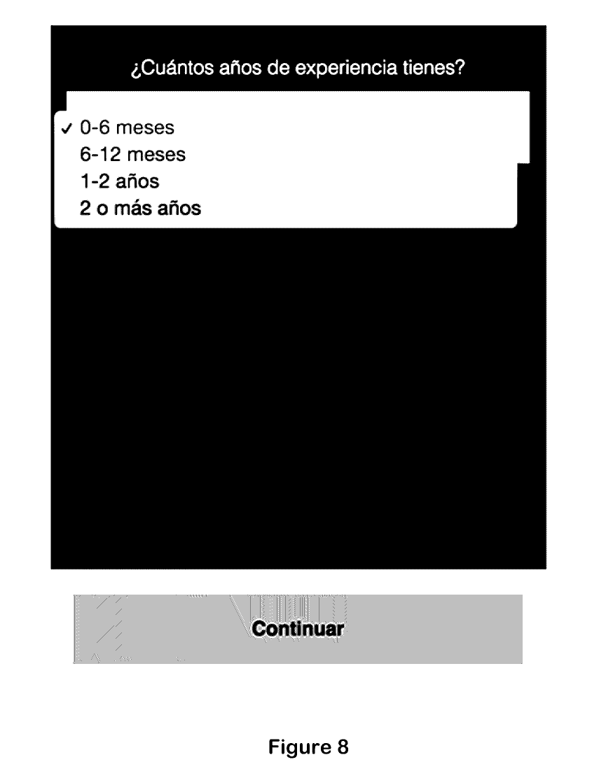

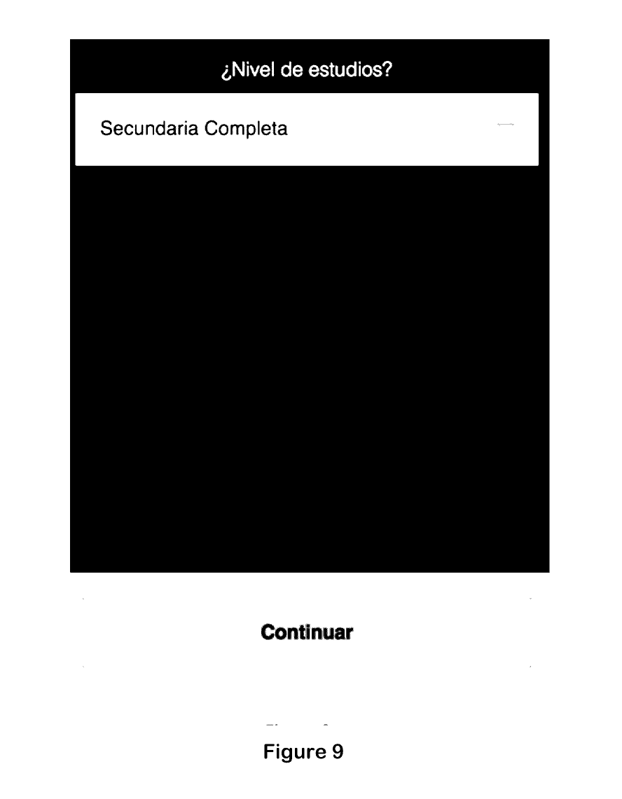

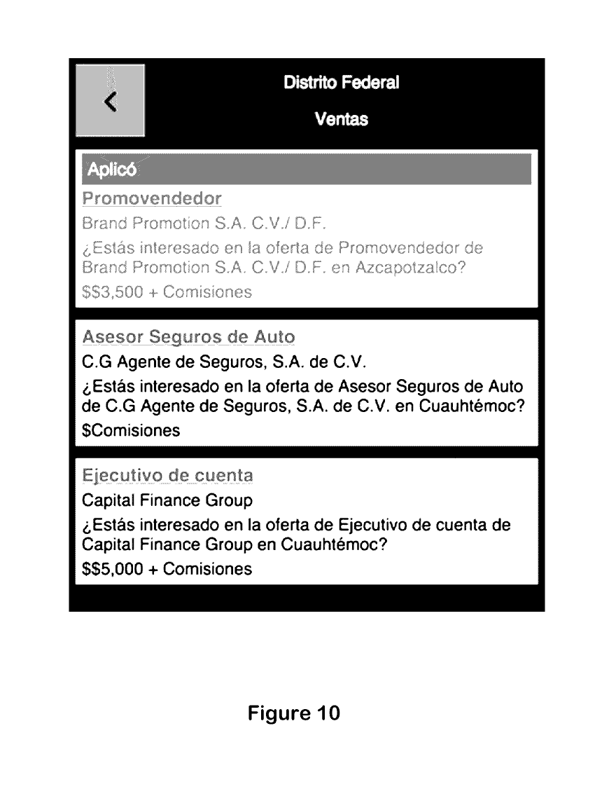

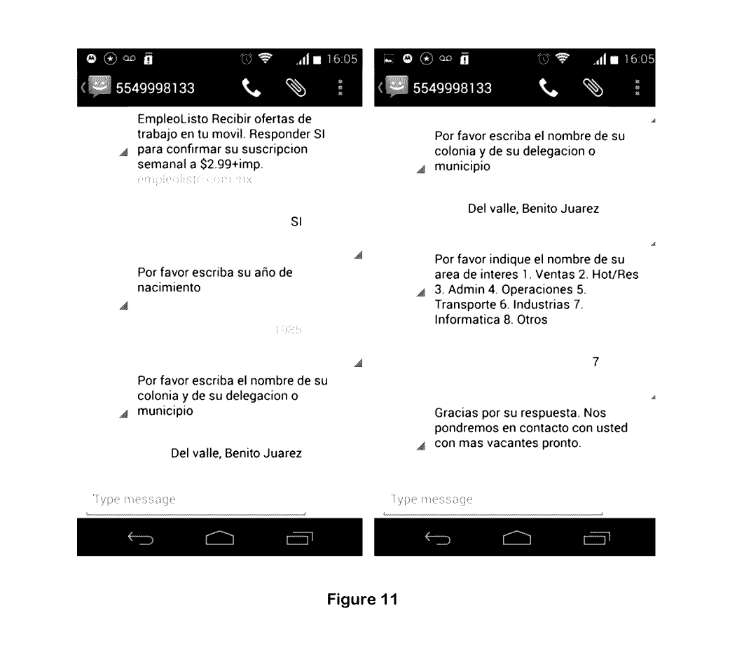

FIG. 4 shows functional diagram of the invention's methodology. The dynamic databases (102, 203, 104) of the job offers, candidate profiles and records are linked to the atomic clocks (501, 502 and 503) which allow synchronizing the search engine-classifiers (103 or 204) of candidate and job databases in order to extract results that match the original user's profile, along with its updates, as well as with previously existing job offers and their updates, sending (504) to employer and candidate information regarding each other cyclically until the employer or the candidate is unsubscribed from the databases or the job offer is no longer available.

The job offer and candidate data search engine-classifiers (103 or 204) extract information from candidates who meet at least one variable required by a job offer vacancy; the synchronization of databases, the search engine-classifier and atomic clocks extract the data that meet at least one requirement or all the requirements, sending to the employer the information which can meet from 50% to 100% of the job offer variables, executing the steps in FIGS. 3 and 4 until the employer or the candidate are unsubscribed from the databases, or the vacancy is no longer available.

The specifications described here do not intend to limit the scope of the invention whenever a technician may apply the invention to any information platform of information or user device; therefore the invention's specifications should be understood in its most broad scope.

1. A system for information management comprising a computer, communication interface, dynamic associated databases which can be modified online and a method implemented in the computer comprising the following steps:
a) receive information request (by employers, headhunters, profile seekers, etc.);
b) determine the conditions associated to the received request;
d) receive a candidate's request (user profile, person profile, animal or object profile);
c) compare the conditions of step b) with step d); where, if the information matches, an electronic communication is sent to the employer and the candidate.

2. A system for information management comprising a computer, a communication interface and a method implemented in the computer of the claim 1, where a data search engine-classifier classifies the information that matches the application of the step a).

3. A system for information management comprising a computer, a communication interface and a method implemented in the computer from the claim 2, where the classified information is sent to the information storage center and contact data management from which an electronic communication is sent to the contact using information stored in the data information and contact data management storage center.

4. A system for information management comprising a computer, a communication interface and a method implemented in the computer from the claim 3, where the contact media can be phone calls, SMS, Whatsapp®, twitter®, Facebook®, fax, e-mails, voice or video data or any other system of remote communication which allows simultaneously receiving information and its storage.

5. A system for information management comprising a computer, a communication interface and a method implemented in the computer from the claim 1, and also comprising a tracking database which classifies and stores second communications from different databases, linking these to the data search engine-classifier for filtering additional information to that originally received in steps a) and d).

6. A system for information management comprising a computer, a communication interface and a method implemented in the computer from the claim 1, also comprising an appointment scheduler database which continuously sends reminders of appointments contained in that database to the employer and to the candidate.
